(19) United States
(12) Patent Application Publication
(10) Pub. No.: US 2011/0014451 A1
(43) Pub. Date: Jan. 20, 2011

(54) NANODIAMOND FILM

(76) Inventor: Toshihiko Tanaka, Ami (JP)

Correspondence Address: BIRCH STEWART KOLASCH & BIRCH, PO BOX 747, FALLS CHURCH, VA, 22040-0747, US

(21) Appl. No.: 12/920,613

(22) PCT Filed: Mar. 2, 2009
(86) PCT No.: PCT/JP2009/053812

§ 371 Date: Sep. 2, 2010

(30) Foreign Application Priority Data
Mar. 3, 2008 (JP) 2008-051811
Mar. 31, 2008 (JP) 2008-090685

(51) Int. Cl. B32B 9/04; B32B 5/00; B32B 27/00; B32B 3/26; B32B 15/04; B32B 17/06; B32B 37/12; B05D 3/02; C01B 31/06; C08L 27/18

(52) U.S. Cl. 428/220; 428/688; 428/304.4; 428/457; 428/426; 156/60; 427/444; 423/446; 524/546

(57) ABSTRACT

Disclosed is a diamond film that can solve a problem of a conventional thin film of diamond which, due to insoluble, infusible and hardly machinable properties of the diamond, is produced by plasma CVD requiring the use of a disadvantageously large apparatus. Specifically, a nanodiamond film, which can be simply produced without the need to use a large apparatus, is disclosed. The nanodiamond film is characterized by comprising a nanodiamond. The nanodiamond film has a thickness of not more than 5000 nm.

### TECHNICAL FIELD

The present invention relates to a film comprising diamond.

### BACKGROUND ART

Diamond has several distinctive properties, for example, high hardness, high thermal conductivity, and the like. Therefore, diamond is used in various fields and is expected to be used in more fields. Besides naturally derived single crystals having been used for jewelry since early times, a large amount of artificially obtained fine particles are used for polishing, cutting, and the like. Also, it is known that a thin film of a diamond-like substance having a composition quite close to diamond is obtained by a method which is called plasma CVD, and various uses are intended, for example, a resin bottle coated with this thin film to suppress the permeation of gas. (See, for example, PATENT DOCUMENT 1).

PATENT DOCUMENT 1: JP 2003-128034 A

### DISCLOSURE OF THE INVENTION

### Problems to be Solved by the Invention

Diamond is insoluble and infusible and is difficult to process. As a diamond film, one manufactured by the above plasma CVD is used. However, there has been a problem that a large-scale apparatus is required to manufacture a diamond film by the plasma CVD. Therefore, there has been a need for a diamond film that can be simply manufactured without using such a large-scale apparatus.

It is an object of the present invention to provide a diamond film that can be simply manufactured without using a large-scale apparatus.

### MEANS FOR SOLVING THE PROBLEMS

The present inventor has diligently studied diamond films. As the result, a diamond film composed of fine particles of a certain type of diamond can be simply manufactured, thus leading to the completion of the present invention.

Specifically, the present invention relates to the following [1] to [25].

[1] A film comprising a nanodiamond.
[2] The film according to [1], consisting of the nanodiamond.
[3] The film according to [1], comprising the nanodiamond and a water-soluble resin.
[4] The film according to any one of [1] to [3], having a film thickness of 5000 nm or less.
[5] A laminated material, wherein the film according to any one of [1] to [4] and a substrate are laminated.
[6] The laminated material according to [5], wherein the surface of the substrate is hydrophilic.
[7] The laminated material according to [5], wherein the surface of the substrate is hydrophobic.
[8] The laminated material according to any one of [5] to [7], wherein the substrate is a substrate composed of a polymer.
[9] The laminated material according to any one of [5] to [9], wherein the substrate is a substrate composed of a fluorine material or coated with a fluorine material.
[10] The laminated material according to [6], wherein the substrate is porous.
[11] The laminated material according to any one of [5] to [7], wherein the substrate is a substrate composed of a metal.
[12] The laminated material according to any one of [5] to [7], wherein the substrate is a substrate composed of an oxide.
[13] The laminated material according to any one of [5] to [7], wherein the substrate is a substrate composed of a nitride.
[14] The laminated material according to any one of [5] to [7], wherein the substrate is a substrate composed of a glass material.
[15] A laminated material, wherein the film according to any one of [1] to [4], a tacky material, and a substrate are laminated.
[16] A method for manufacturing the laminated material according to any one of [5] to [15], wherein the substrate is a substrate composed of a tacky material or coated with a tacky material, the method comprising a step of bringing the substrate into contact with the film according to any one of [1] to [4].
[17] A putty comprising a diamond-like substance, water, and a resin.
[18] The putty according to [17], containing the diamond-like substance in an amount of more than 20% by weight of the weight of the putty excluding a solvent including water.
[19] The putty according to [17] or [18], wherein the diamond-like substance is a nanodiamond.
[20] The putty according to any one of [17] to [19], wherein the content of the water is 30% by weight or more.
[21] The putty according to any one of [17] to [20], further comprising a solvent other than water.
[22] A method for manufacturing the putty according to any one of [17] to [21], comprising mixing a dispersion of a diamond-like substance with a resin solution.
[23] A method for manufacturing the film according to [3], comprising a step of drying the putty according to any one of [17] to [21].
[24] A method for manufacturing the laminated material according to any of [5] to [15], comprising a step of drying the putty according to any of [17] to [21].
[25] The method according to claim 24 for manufacturing a laminated material, wherein the surface of the substrate is hydrophilic.

### ADVANTAGES OF THE INVENTION

The film of the present invention can be simply manufactured without using a large-scale apparatus, such as plasma CVD. Also, the film of the present invention can be transparent by giving a film suitable thickness. Further, it is also possible to adjust the adhesive properties of the film of the present invention to a substrate and to conversely transfer the film of the present invention from a substrate by suitably selecting the substrate. Because the film of the present invention comprises diamond, the film of the present invention has an excellent thermal conductivity, an excellent refractive index, and the like, and therefore can be used in various applications such as heat sinks and optics. As the result, the present invention is industrially very important. Also, the putty of the present invention has excellent processability and can be used in the manufacture of the film of the present invention. And further, since the putty of the invention, in and of itself, comprises diamond, the higher content of diamond can be provided. As the result, the putty of the present invention can exhibit properties derived from diamond, such as thermal conductivity.

### BEST MODE FOR CARRYING OUT THE INVENTION

First, the film of the present invention will be described in detail.

The film of the present invention comprises the nanodiamond.

Generally, the content of the nanodiamond contained in the film of the present invention is preferably high in terms of exhibiting properties derived from diamond. Specifically, the content of the nanodiamond is usually 10% by weight or more and 100% by weight or less, preferably 30% by weight or more and 100% by weight or less, more preferably 50% by weight or more and 100% by weight or less, further preferably 60% by weight or more and 100% by weight or less, still more preferably 70% by weight or more and 100% by weight or less, and particularly preferably 90% by weight or more and 100% by weight or less.

The nanodiamond used in the present invention will be described.

The nanodiamond can be appropriately selected from the well-known nanodiamonds for use. Nanodiamond is very fine diamond particles. The primary particle diameter of the nanodiamond used in the present invention is usually in the range of 100 nm or less and 1 nm or more, preferably in the range of 50 nm or less and 2 nm or more, more preferably in the range of 30 nm or less and 2 nm or more, and particularly preferably in the range of 10 nm or less and 3 nm or more.

Such nanodiamond can be usually manufactured by a detonation method and needs to have the property of being dispersed in a liquid. Commercial nanodiamonds, such as NanoAmando (trade name) sold by NanoCarbon Research Institute Co., Ltd., can be used.

When it is desired to avoid coloration, the thickness of the film of the present invention is preferably small. Specifically, the film thickness is preferably 5000 nm or less.

The film of the present invention may include other components in a range in which its purpose is not compromised. Examples of such components can include a solvent (water, alcohols, and the like), a plasticizer, and a binder. Because the film is rich in plastic in a state comprising a large amount of a solvent, the film can be used by drying the solvent according to purposes after it is used in a state comprising a large amount of the solvent during the formation. As the solvent, water and alcohols are preferred, and water is particularly preferred. Specific examples of the film comprising such other components can also include those obtained by forming the putty of the present invention into a film and drying it.

A method for manufacturing the film of the present invention will be described. One preferred method for manufacturing the film of the present invention is a method for dispersing a nanodiamond powder in a solvent and applying the dispersion to a substrate. In that case, examples of the solvent can include alcohols, ethers, ketones, organic halogen compounds, aromatic compounds, and water. Water and alcohols are preferred and water is most preferred because the nanodiamond particles are more uniformly dispersed.

As for the dispersion method of the nanodiamond particles in the solvent, the nanodiamond particles may be dispersed simply by stirring in some cases, but the nanodiamond particles can also be dispersed by an ultrasonic treatment or a rotary homogenizer treatment. In addition, a dispersant, such as a cationic surfactant, an anionic surfactant, or a nonionic surfactant, may be added to the solvent.

The substrate is not particularly limited, as long as it is stable and smooth and is insoluble in the solvent used. Examples of the material of the substrate can include metals, ceramics (oxides, nitrides, and the like), resins, and glass. The adhesion between the thin film obtained and the substrate can be adjusted by the properties of the material of the surface of the substrate. For example, when the water dispersion of nanodiamond is used as usual, if a thin film is formed on a hydrophilic surface of glass or a metal, such as aluminum, it is relatively easily detached. However, if a thin film is formed on a polymer material or a hydrophobic surface obtained by coating with a polymer material or the like, the detachment thereof is relatively difficult. Such a polymer material is not particularly limited, as long as it is insoluble in water. Examples of such a polymer material can include polyethylene, polystyrene, paraffin, and fluororesins. Specific examples of the fluororesins can include polymers having a perfluoroalkyl group, and polytetrafluoroethylene and derivatives thereof.

Further, the thin film can be made it difficult to detach by a method for modifying the surface with various organic compounds, other than by the polymer materials. On the other hand, the nanodiamond film of the present invention can also be transferred onto other substrates. Examples of the transfer method include a method for pressure-bonding a tacky material or a substrate coated with a tacky material and peeling it off. Specifically, for example, various commercial adhesive tapes can be used. Not only materials having tackiness at room temperature, but also materials exhibiting tackiness at increased temperature can be used as the tacky material. Specific examples of the materials can include thermoplastic resins (polyethylene and the like).

The application method can be appropriately selected from the well-known methods for use. Specific examples of the well-known methods can include casting, spin coating, bar coating, blade coating, roll coating, gravure printing, screen printing, and ink jetting.

After the application, drying may be performed according to intended uses. Methods that can be industrially usually used, such as natural drying, hot air heating and drying, infrared heating and drying, high-frequency heating and drying, vacuum drying, and freeze drying, can be used as the drying method.

Next, the putty of the present invention will be described in detail.

The putty of the present invention comprises a diamond-like substance, water, and a resin. The diamond-like substance can be appropriately selected from the well-known diamond-like substances for use. In terms of processability, nanodiamond and diamondoid are preferred, and nanodiamond is particularly preferred. Among diamond-like substances, nanodiamonds having the property of being well dispersed in water are preferred in that the putty of the present invention can be easily manufactured. Specifically, the well-known nanodiamonds, such as NanoAmando (trade name) sold by NanoCarbon Research Institute Limited Center, can be used. As for a liquid in which the diamond-like substance is dispersed, various organic solvents (alcohols, ethers, ketones, organic chlorines, aromatic compounds, and the like) in addition to water can also be used as long as they are compatible with water. In terms of dispersibility, only water or mixed liquids of water and alcohols is preferred.

The putty of the present invention comprises at least one or more resin components. Such a resin component can be appropriately selected from the well-known resins for use. Examples of such resins include polyolefins (polyethylene, polypropylene, polystyrene, and the like), acryls (polymethylmethacrylate and the like), nylons, polyethers, polyethersulfones, polycarbonates, polyvinyl alcohols, celluloses, and starches. The water-soluble resins are preferred in that the putty can be easily manufactured. Examples of such water-soluble resins include polyvinyl alcohols and starches.

The putty of the present invention may comprise other components in a range in which its purpose is not compromised, other than the diamond-like substance, the resin, and water. Examples of such components can include a plasticizer, a colorant, and a dispersant.

The content of the diamond-like substance included in the diamond-like putty of the present invention is generally more than 20% by weight and 90% by weight or less, preferably 25% by weight or more and 90% by weight or less, more preferably 30% by weight or more and 90% by weight or less, and particularly preferably 60% by weight or more and 80% by weight or less, with respect to the weight of the diamond-like putty excluding the solvent including water. When the diamond-like putty is formed in a state including a large amount of the solvent, such as water, the content of the solvent is 30% by weight or more and 75% by weight or less, preferably 50% by weight or more and 70% by weight or less.

Next, a method for manufacturing the diamond-like putty of the present invention will be described. The diamond-like putty of the present invention is generally obtained by mixing the components together. As for a preferred manufacturing method, the diamond-like putty of the present invention is obtained by a method for mixing a dispersion of a diamond-like substance and a solution of a resin. As the solution of a diamond-like substance, a dispersion of nanodiamond is preferred. The solvent of the dispersion preferably comprises water or a mixed solvent of water and an alcohol as the main component, and a substance that can be mixed with water or the alcohol even in a small amount can be appropriately added to the solvent as a secondary component.

Next, a method for manufacturing the film of the present invention comprising using the putty of the present invention will be described. The putty of the present invention is generally flexible and can be subjected to deformation processing. Therefore, the film of the present invention can be obtained by forming the putty into a film by the well-known methods and then drying it. Examples of the well-known methods can include rolling, casting, drawing, casting, extrusion, cutting, and cutting-off. Generally, a putty is in the form of clay in many cases, and a film can be relatively preferably obtained, for example, by rolling. A putty comprising a water-soluble resin generally has a strong tendency to adhere to a hydrophilic material. Therefore, when the putty is rolled on a substrate having a hydrophilic surface via a material having a hydrophobic surface, the rolled putty adheres onto the substrate, and a film can be preferably obtained on the substrate by drying the putty. Also, when the substrate having a hydrophilic surface is porous, part of the putty can penetrate into the substrate, resulting in a stronger adhesion. Examples of such a porous substrate having a hydrophilic surface can include various papers, and films used for filters, such as a Millipore filter.

### EXAMPLES

Examples are illustrated below to describe the present invention in more detail, but the present invention is not limited to these.

### Example 1

A water dispersion comprising 5% nanodiamond [NanoAmando (trade name) manufactured by NanoCarbon Research Institute Co., Ltd.] was dropped on a slide glass and dried. A transparent film exhibiting a slightly brown color was formed. This film was easily detached from the glass. When an adhesive tape (CELLOTAPE (registered trademark) manufactured by Nichiban Co., Ltd.) was affixed to the film on the glass and then peeled off, a nanodiamond film having a slightly brown metallic luster was formed on the tape.

### Example 2

An ultra-thin film of polytetrafluoroethylene was made on a slide glass by the method described in Nature, vol. 352, pp. 414 to 417 (1991). A water dispersion comprising 5% nanodiamond (NanoAmando (trade name) manufactured by NanoCarbon Research Institute Co., Ltd.) was dropped on this substrate and dried. A nanodiamond film having a slightly brown metallic luster was obtained. This film was less easily detached than on the glass.

### Example 3

A water dispersion comprising 5% nanodiamond (NanoAmando (trade name) manufactured by NanoCarbon Research Institute Co., Ltd.) was dropped on aluminum foil and dried. A transparent film exhibiting a slightly brown color was formed. This film was easily peeled. When an adhesive tape (CELLOTAPE (registered trademark) manufactured by Nichiban Co., Ltd.) was affixed to the film on the foil and then peeled off, a nanodiamond film having a slightly brown metallic luster was formed on the tape. This film was easily detached from the foil.

### Example 4

A water dispersion comprising 5% nanodiamond (NanoAmando (trade name) manufactured by NanoCarbon Research Institute Co., Ltd.) was dropped on a paraffin film (Parafilm (trade name)) and dried. A transparent film exhibiting a slightly brown color was formed. This film was less easily detached than on the glass.

### Example 5

A water dispersion comprising 5% nanodiamond (NanoAmando (trade name) manufactured by NanoCarbon Research Institute Co., Ltd.) was dropped on a polystyrene sheet and dried. A transparent film exhibiting a slightly brown color was formed. This film was less easily detached than on the glass.

### Example 6

1.57 parts by weight of a polysaccharide (Pullulan (trade name) manufactured by Hayashibara Biochemical Laboratories, Inc.) was dissolved in water to make 63.1 parts by weight of a 2.5% solution. While this Pullulan solution was stirred, 31.3 parts by weight of a water dispersion comprising 5% nanodiamond (NanoAmando (trade name) manufactured by NanoCarbon Research Institute Co., Ltd.) was slowly dropped. Then, a gray precipitate was obtained. The precipitate was filtered and washed with 100 parts by weight of water, and then, 7.26 parts by weight of the clay-like precipitate was recovered. At this time, the filtrate was transparent. This clay-like precipitate was soft, and was freely deformed when force was applied. This clay-like precipitate hardened gradually when it was air-dried. When 1 part by weight of this clay-like precipitate was placed in a glass container and dried on a hot plate at 150° C., the weight decreased to 0.29 parts by weight. Therefore, about 71% water is contained in the clay-like precipitate.

Here, the filtrate was not colored, and therefore, it can be considered that most of the nanodiamond precipitated. Therefore, the clay-like precipitate (putty) contains 22% by weight of nanodiamond. The solid after drying contains about 75% by weight of nanodiamond and about 25% by weight of Pullulan. Further, such a clay-like substance contains a large amount of nanodiamond and thus has a high thermal conductivity.

### Example 7

A small piece of the putty prepared in Example 6 was placed on glass. The putty was rolled under a polytetrafluoroethylene sheet [HYPER-SHEET (trade name, manufactured by Japan Gore-Tex Inc.), thickness: about 1 mm] pressed against the putty, which could be deformed into a film having a thickness of about 0.1 to 0.05 mm. Then, the sheet adhered during the rolling was peeled off, and the film was found attached to the glass. This was air-dried, and a black film could be obtained on the glass.

### Example 8

A small piece of the putty prepared in Example 6 was placed on paper. The putty was rolled under the polytetrafluoroethylene sheet pressed against the putty, which could be deformed into a film having a thickness of about 0.1 to 0.05 mm. Then, the sheet adhered during the rolling was peeled off, and the film was found attached to the paper. This film was air-dried, and a black film could be obtained on the paper.

1. A film comprising a nanodiamond.

2. The film according to claim 1, consisting of the nanodiamond.

3. The film according to claim 1, comprising the nanodiamond and a water-soluble resin.

4. The film according to any one of claims 1 to 3, having a film thickness of 5000 nm or less.

5. A laminated material, wherein the film according to claim 1 and a substrate are laminated.

6. The laminated material according to claim 5, wherein the surface of the substrate is hydrophilic.

7. The laminated material according to claim 5, wherein the surface of the substrate is hydrophobic.

8. The laminated material according to claim 5, wherein the substrate is a substrate composed of a polymer.

9. The laminated material according to claim 5, wherein the substrate is a substrate composed of a fluorine material or coated with a fluorine material.

10. The laminated material according to claim 6, wherein the substrate is porous.

11. The laminated material according to claim 5, wherein the substrate is a substrate composed of a metal.

12. The laminated material according to claim 5, wherein the substrate is a substrate composed of an oxide.

13. The laminated material according to claim 5, wherein the substrate is a substrate composed of a nitride.

14. The laminated material according to claim 5, wherein the substrate is a substrate composed of a glass material.

15. A laminated material, wherein the film according to claim 1, a tacky material, and a substrate are laminated.

16. A method for manufacturing the laminated material according to claim 5, wherein the substrate is a substrate composed of a tacky material or coated with a tacky material, the method comprising a step of bringing the substrate into contact with a film comprising a nanodiamond.

17. A putty comprising a diamond-like substance, water, and a resin.

18. The putty according to claim 17, containing the diamond-like substance in an amount of more than 20% by weight of the weight of the putty excluding a solvent including water.

19. The putty according to claim 17 or 18, wherein the diamond-like substance is a nanodiamond.

20. The putty according to claim 17, wherein the content of the water is 30% by weight or more.

21. The putty according to claim 17, further comprising a solvent other than water.

22. A method for manufacturing the putty according to claim 17, comprising mixing a dispersion of a diamond-like substance with a resin solution.

23. A method for manufacturing the film according to claim 3, comprising a step of drying a putty comprising a diamond-like substance, water, and a resin.

24. A method for manufacturing the laminated material according to claim 5, comprising a step of drying a putty comprising a diamond-like substance, water, and a resin.

25. The method according to claim 24 for manufacturing a laminated material, wherein the surface of the substrate is hydrophilic.
